(19) United States
(12) Patent Application Publication
(10) Pub. No.: US 2009/0220251 A1
(43) Pub. Date: Sep. 3, 2009

(54) Image Forming Apparatus and Method of Determining Update of Identification Information

(75) Inventor: Hiroshi TANAKA, Nagano (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/434,522

(22) Filed: May 1, 2009

Related U.S. Application Data
(62) Division of application No. 11/201,775, filed on Aug. 11, 2005.

(30) Foreign Application Priority Data
Aug. 13, 2004 (JP) 2004-235762
Sep. 9, 2004 (JP) 2004-261968

(51) Int. Cl. G03G 15/08

(52) U.S. Cl. 399/12; 399/27

(57) ABSTRACT

An image forming apparatus includes a developing rotary unit configured to attach a plurality of developing cartridges, the developing cartridges respectively having cartridge storage portions for respectively storing identification information about the corresponding developing cartridges, a communicating unit that communicates with the cartridge storage portions, a storage unit configured to store the identification information, and a control unit that reads the identification information from the cartridge storage portions of all the developing cartridges through the communicating unit and writes the read identification information into the storage unit so as to update the identification information stored in the storage unit when a power supply of the image forming apparatus is turned ON or a body cover for the developing rotary unit is closed.

### BACKGROUND OF THE INVENTION

The present invention relates to an image forming apparatus such as a color printer or a facsimile which forms an image by using an electrophotographic technique and a method of determining update of identification information, and more particularly to an image forming apparatus in which a cartridge storage portion for storing identification information including information about a lifetime is provided in a developing cartridge detachable from the image forming apparatus.

In general, an image forming apparatus such as a color printer using an electrophotographic technique includes an image forming unit constituted by a photosensitive member, a charging unit for charging the outer peripheral surface of the photosensitive member, an exposing unit for selectively exposing the outer peripheral surface of the photosensitive member to form an electrostatic latent image, and a developing cartridge for developing the electrostatic latent image into a toner image. A developing rotary having an almost cylindrical shape and supported rotatably is provided in an adjacent position to the photosensitive member, and developing cartridges (hereinafter referred to as cartridges) for four colors (yellow Y, magenta M, cyan C and black K) are exchangeably attached to the developing rotary.

Moreover, cartridge storage portions (hereinafter referred to as cartridge memories) are provided in the cartridges respectively, and the cartridge memories store identification information with which cartridges for a toner color, the amount of a residual toner, a driving time, the number of sheets to be printed and a manufacturing date accommodated in cases can be individually identified, respectively. Each of the cartridges is communicated with a control unit for controlling the operation of an image forming apparatus (hereinafter referred to as a body) through a communicating unit, and the identification information written to each of the cartridge memories is read by the control unit and is stored in a body memory. For the memory provided in each of the cartridges, a nonvolatile memory is usually used.

Then, the control unit of the body updates information about the lifetime of the cartridge such as the amount of the residual toner in the cartridge, the driving time and the number of sheets to be printed every time a development is carried out, and communicates with the cartridge memory through the communicating unit to write the current identification information to the cartridge memory when a predetermined event is generated.

As a technique for carrying out the communication of the memory of each cartridge with the control unit on the body side, there has been known a method of performing the read/write of the memory of the cartridge through an antenna portion in non-contact (for example, see JP-A-2002-296984 and JP-A-2000-187415).

Since the cartridge can be exchanged, it is also possible to propose a using way in which the cartridge in use is once taken out and stored and a new cartridge is attached to carry out mass printing, and the same cartridge is taken out and an old stored cartridge is reattached when the mass printing is to be performed, for example. In such a using method, it is necessary to write the current data on identification information about a lifetime to a cartridge memory and to cause the identification information about the lifetime to be coincident with the current data before taking out the cartridge. The reason is that the information about the lifetime which is read from the cartridge memory is inaccurate when the reattachment is carried out. For this reason, it is impossible to carry out the accurate lifetime management of the cartridge.

Also, in JP-A-2002-296984, when a cartridge is to be taken out, the control unit of a body communicates with a cartridge memory and writes the current data on the cartridge to the cartridge memory. In JP-A-2000-187415, moreover, when a cartridge is newly attached, the control unit of the body communicates with the cartridge memory of the cartridge thus attached and reads identification information written to the cartridge memory.

In the image forming apparatus of this type, an exchange position (an attaching and removing position) is predetermined as a position in which a cartridge can be normally taken out of a developing rotary, and the control unit of the body rotates a developing rotary to place the cartridge specified to be taken out in the exchange position when a predetermined operation is carried out in the operating portion of the body. Consequently, a user carries out an operation for opening the cover of the body and taking out a desirable cartridge, and attaching a new cartridge to the developing rotary and closing the cover, and can thus exchange the cartridge. By the execution of a serial operation for giving an instruction for taking out the cartridge and opening and closing the cover in the operating portion, the control unit of the body can recognize that the cartridge has been normally exchanged.

Thus, the cartridge cannot be taken out of the developing rotary in a normal state. There is a possibility that the cover of the body might be opened or the power supply of the body might be turned OFF due to the malfunction of the user when the developing rotary is rotated as in printing or an initialization processing to be carried out at time of power-ON. In such a case, the rotation of the developing rotary is stopped. In some cases in which the cover of the body is opened or the power supply of the body is turned OFF, however, a cartridge for a certain color is stopped in an attaching and removing position by chance.

At this time, it can be supposed that the user takes out the cartridge placed in the exchange position and attaches another cartridge for the same color. Referring to the exchange of the cartridge which is not normal, usually, the control unit of the body cannot detect that the cartridge for the certain color has been exchanged.

In this case, the identification information about the cartridge for the same color which is managed by the control unit of the body at this time is related to the cartridge taken out, and is not coincident with identification information written to the cartridge memory of a cartridge which is newly attached. For this reason, there is a problem in that an accurate lifetime management cannot be carried out for the cartridge if printing is then performed in this state.

For example, description will be given to the amount of a residual toner to be one of the information about the lifetime in the identification information and there is the following problem. For example, it is assumed that the situation described above is generated and a cartridge for a Y color is taken out, and the amount of the residual toner in the cartridge for the Y color is 1%. At this time, the control unit of the body stores 1% of the amount of the residual toner in relation to the cartridge for the Y color. On the other hand, it is assumed that the amount of the residual toner in a cartridge for a Y color which is newly attached is 90%.

As described above, the control unit of the body updates the amount of the residual toner in the cartridge for the Y color every development. However, the amount of the residual toner stored in relation to the cartridge for the Y color by the control unit of the body is 1%. Therefore, the control unit of the body updates the amount of the residual toner from 1% every development. When an event in which the identification information of the cartridge memory is to be updated is generated, the current identification information including information about a lifetime is written to the cartridge memory of the cartridge for the Y color. When the amount of the residual toner is 0%, it is decided that the cartridge is empty so that a request for exchanging the cartridge for the Y color is given to the user. In this case, accordingly, it is decided that the cartridge for the Y color which is newly attached is empty irrespective of the sufficient amount of the residual toner. Thus, there is a problem in that the cartridge for the Y color cannot be used.

To the contrary, assuming that the amount of the residual toner in the cartridge for the Y color which is taken out is 90% and the amount of the residual toner in the cartridge for the Y color which is newly attached is 1%, the control unit of the body recognizes that the toner still remains in a sufficient amount in the cartridge for the Y color which is newly attached. Actually, the amount of the residual toner is small. For this reason, there is a problem in that a situation in which a printed image is blurred is generated in the case that the printing is continuously carried out.

By the way, in JP-A-2002-296984, in the case that an instruction for taking out a cartridge is given, identification information is always written to a cartridge memory. For this reason, a long waiting time is required for a user to actually take out the cartridge. More specifically, in an image forming apparatus of this type, a position in which the control unit of a body can communicate with the cartridge memory and a position in which the cartridge can be taken out are usually determined. In the case that an instruction for taking out a certain cartridge is given, there is performed an operation for first rotating a developing rotary to move the cartridge specified to be taken out to the position in which the communication with the control unit of the body can be carried out, and writing the current identification information from the control unit of the body to the cartridge memory of the same cartridge therein, and then rotating the developing rotary to move the same cartridge to the take-out position. A long time is required for actually taking out the same cartridge.

On the other hand, a user desires to quickly take out a certain cartridge when carrying out such an operation as to give an instruction for taking out the same cartridge. For this purpose, in the case that the instruction for taking out the cartridge is given, it is preferable to immediately rotate the developing rotary, thereby moving the cartridge to the take-out position. Consequently, it is possible to shorten the waiting time of the user from the execution of the operation for giving the instruction for taking out the cartridge to the actual take-out of the cartridge. In such a case, however, there is a possibility that the identification information written to the cartridge memory of the cartridge thus taken out might not be the current as described above.

### SUMMARY OF THE INVENTION

Therefore, it is a first object of the invention to provide an image forming apparatus and a method of determining update of identification information capable of carrying out an accurate lifetime management for a cartridge also in the case that the cartridge is exchanged when the control unit of the body cannot recognize that the cartridge is exchanged, for example, when the cover of the body is opened during the rotation of a developing rotary or a power supply is turned OFF.

Further, a second object of the invention is to provide an image forming apparatus and a method of determining update of identification information capable of immediately deciding whether or not the current identification information is written to the cartridge memory of the cartridge when an instruction for take-out is given.

Moreover, a third object of the invention is to provide an image forming apparatus and a method of determining update of identification information capable of taking out the cartridge to shorten the waiting time of a user in the case that the current identification information is written to the cartridge memory, and taking out the same cartridge after writing the current identification information to the cartridge memory of the cartridge and writing the current identification information to the cartridge memory of the cartridge thus taken out in the case that the current identification information is not written based on the result of the decision.

In order to achieve the above object, according to the present invention, there is provided an image forming apparatus, comprising:

a developing rotary unit configured to attach a plurality of developing cartridges, the developing cartridges respectively having cartridge storage portions for respectively storing identification information about the corresponding developing cartridges;

a communicating unit that communicates with the cartridge storage portions;

a storage unit configured to store the identification information; and

a control unit that reads the identification information from the cartridge storage portions of all the developing cartridges through the communicating unit and writes the read identification information into the storage unit so as to update the identification information stored in the storage unit when a power supply of the image forming apparatus is turned ON or a body cover for the developing rotary unit is closed.

According to the present invention, there is also provided an image forming apparatus, comprising:

a developing rotary unit configured to attach a plurality of developing cartridges, the developing cartridges respectively having cartridge storage portions for respectively storing identification information about the corresponding developing cartridges;

a communicating unit that communicates with the cartridge storage portions;

a storage unit configured to store the identification information; and

a control unit that reads the identification information from the cartridge storage portions of all the developing cartridges through the communicating unit, compares the read identification information with the identification information stored in the storage unit and determines whether the identification information stored in the storage unit is updated with the read identification information based on a result of the comparison when a power supply of the image forming apparatus is turned ON or a body cover for the developing rotary unit is closed.

Preferably, the identification information include information about amounts of residual toners of the respective developing cartridges.

According to the present invention, there is also provided an image forming apparatus, comprising:

a developing rotary unit configured to attach a plurality of developing cartridges, the developing cartridges respectively having cartridge storage portions for respectively storing identification information about the corresponding developing cartridges;

a communicating unit that communicates with the cartridge storage portions;

a storage unit configured to store the identification information; and

a control unit that determines whether any of the developing cartridges is located at an exchange position in the developing rotary unit and determines whether the identification information stored in the storage unit is updated based on a result of the determination when a power supply of the image forming apparatus is turned ON or a body cover for the developing rotary unit is closed.

Preferably, the control unit reads the identification information from the cartridge storage portion located at the exchange position through the communicating unit and compares the read identification information with the identification information stored in the storage unit. The control unit determines whether the identification information stored in the storage unit is updated based on a result of the comparison.

According to the present invention, there is also provided a method of determining update of identification information, comprising:

reading identification information from cartridge storage portions of all developing cartridges through a communication unit; and

writing the read identification information into a storage unit of an image forming apparatus so as to update the identification information stored in the storage unit,

wherein the reading process and the writing process are performed when a power supply of the image forming apparatus is turned ON or a body cover for a developing rotary unit of the image forming apparatus is closed; and

wherein the developing rotary unit includes the developing cartridges, the developing cartridges respectively having the cartridge storage portions for respectively storing the identification information about the corresponding developing cartridges.

According to the present invention, there is also provided a method of determining update of identification information, comprising:

reading identification information from cartridge storage portions of all developing cartridges through a communicating unit;

comparing the read identification information with identification information stored in a storage unit of an image forming apparatus; and

determining whether the identification information stored in the storage unit is updated with the read identification information based on a result of the comparing process,

wherein the reading process, the comparing process and the determining process are performed when a power supply of the image forming apparatus is turned ON or a body cover for a developing rotary unit of the image forming apparatus is closed; and

wherein the developing rotary unit includes the developing cartridges, the developing cartridges respectively having the cartridge storage portions for respectively storing the identification information about the corresponding developing cartridges.

Preferably, the identification information include information about amounts of residual toners of the respective developing cartridges.

According to the present invention, there is also provided a method of determining update of identification information, comprising:

determining whether any of developing cartridges is located at an exchange position in a developing rotary unit of an image forming apparatus; and

determining whether identification information stored in a storage unit of the image forming apparatus is updated based on a result of the determining process of the exchange position,

wherein the determining process of the exchange position and the determining process of the update are performed when a power supply of the image forming apparatus is turned ON or a body cover for the developing rotary unit of the image forming apparatus is closed; and

wherein the developing rotary unit includes the developing cartridges, the developing cartridges respectively having the cartridge storage portions for respectively storing the identification information about the corresponding developing cartridges.

Preferably, the method further comprising;

reading the identification information from the cartridge storage portion located at the exchange position through a communicating unit; and

comparing the read identification information with the identification information stored in the storage unit,

wherein the determining process is performed based on a result of the comparing process.

By the above configurations and methods, when the power supply is turned ON or the body cover is closed, therefore, the identification information about the developing cartridge for each color in the storage portions are forcibly updated. Also in the case that the developing cartridge is exchanged when the control unit cannot recognize that the developing cartridge is exchanged, for example, when the body cover is opened during the rotation of the developing rotary unit or the power supply is turned OFF, consequently, an accurate lifetime management can be carried out for the developing cartridge.

By the above configurations and methods, the identification information about the developing cartridge of the storage unit can be updated for only the developing cartridge which is decided to be exchanged actually. Consequently, it is possible to avoid the generation of an error between information about the amount of a residual toner which is managed by the storage unit and information about the actual amount of a residual toner in the developing cartridge. Also in the case that the developing cartridge is exchanged when the control unit cannot recognize that the developing cartridge is exchanged, thus, the accurate lifetime management can be carried out for the developing cartridge.

By the above configurations and methods, whether the exchange has been carried out can be decided with high precision.

By the above configurations and methods, in the case that there is the developing cartridge placed in the exchange position when the power supply is turned ON or the body cover is closed, it can be supposed that the developing cartridge has been exchanged. Thus, it is possible to update the identification information about the developing cartridge of the storage unit. Also in the case that the developing cartridge is exchanged when the control unit cannot recognize that the developing cartridge is exchanged, consequently, it is possible to carry out the accurate lifetime management for the developing cartridge.

According to the present invention, there is also provided an image forming apparatus, comprising:

a developing rotary unit configured to attach a plurality of developing cartridges, the developing cartridges respectively having cartridge storage portions;

a communicating unit that communicates with the cartridge storage portions; and

a storage unit configured to store identification information about amounts of residual toners in the respective developing cartridges, wherein the storage unit includes a first storage region for storing current toner remaining amount information and a second storage region for storing a preceding writing toner remaining amount information.

Preferably, the image forming apparatus further comprising:

a receiving unit that receives an instruction for taking out the developing cartridge; and

a control unit that determines whether the current toner remaining amount information, for the developing cartridge specified by the instruction, stored in the first storage region corresponds to the preceding writing toner remaining amount information about the developing cartridge specified by the instruction, stored in the second storage region,

wherein the developing cartridge specified by the instruction is moved to an exchange position in the developing rotary unit when the current toner remaining amount information is corresponded to the preceding writing toner remaining amount information; and

wherein the developing cartridge specified by the instruction is moved to the exchange position after updating the identification information stored in the cartridge storage portion of the developing cartridge specified by the instruction with the current toner remaining amount information through the communication unit when the current toner remaining amount information is not corresponded to the preceding writing toner remaining amount information.

According to the present invention, there is also provided a method of determining update of identification information, comprising:

receiving an instruction for taking out any of developing cartridges;

determining whether a current toner remaining amount information about the developing cartridge specified by the instruction, stored in a first storage region corresponds to a preceding writing toner remaining amount information about the developing cartridge specified by the instruction, stored in a second storage region;

moving the developing cartridge specified by the instruction to an exchange position in a developing rotary unit when the current toner remaining amount information is corresponded to the preceding writing toner remaining amount information; and

moving the developing cartridge specified by the instruction to the exchange position after updating the identification information stored in the cartridge storage portion of the developing cartridge specified by the instruction with the current toner remaining amount information through a communication process when the current toner remaining amount information is not corresponded to the preceding writing toner remaining amount information.

In the above configurations and methods, by deciding whether or not the information written to the first storage region and the second storage region are coincident with each other, therefore, it is possible to easily and immediately decide whether or not the current toner remaining amount information is written to the cartridge storage portion.

In the above configurations and methods, when the current toner remaining amount information is written to the cartridge storage portion of the developing cartridge specified by the instruction, therefore, the same developing cartridge is taken out immediately. Consequently, it is possible to shorten the waiting time of a user. In the case that the current toner remaining amount information is not written, furthermore, the current toner remaining amount information is written to the cartridge storage portion of the developing cartridge and is then taken out. Consequently, it is possible to write the current toner remaining amount information to the cartridge storage portion of the developing cartridge thus taken out.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a view showing main components constituting a printer;

FIGS. 2A to 2C are typical views showing the stop position of a developing rotary unit;

FIG. 3 is a diagram showing the electrical structure of the printer;

FIGS. 4A and 4B are diagrams for explaining the structure of a cartridge memory;

FIG. 5 is a diagram for explaining that two storage regions having the current toner remaining amount information storage region and a preceding writing toner remaining amount information storage region are allocated to a region of a body memory for storing information about the amount of a residual toner in each cartridge;

FIG. 6 is a flowchart showing the processing of a unit controller in printing;

FIG. 7 is a flowchart for explaining a first embodiment of a processing to be carried out when a power supply is turned ON or a body cover is closed according to the invention;

FIG. 8 is a flowchart for explaining a second embodiment of the processing to be carried out when the power supply is turned ON or the body cover is closed according to the invention;

FIG. 9 is a flowchart for explaining a third embodiment of the processing to be carried out when the power supply is turned ON or the body cover is closed according to the invention;

FIG. 10 is a flowchart for explaining a fourth embodiment of the processing to be carried out when the power supply is turned ON or the body cover is closed according to the invention; and

FIG. 11 is a flowchart for explaining an operation when an instruction for taking out a cartridge for a certain color is received via a take-out operating portion.

### DETAILED DESCRIPTION OF THE PREFERRED EMBODIMENTS

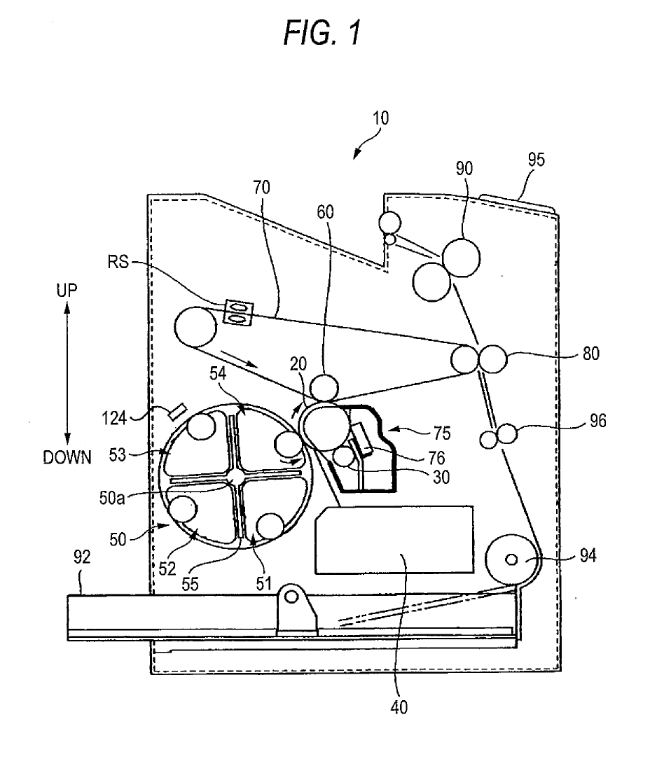

An image forming apparatus (for example, a color printer) according to an embodiment of the invention will be described below with reference to the drawings. FIG. 1 is a schematic view typically showing main components constituting a color printer 10. In FIG. 1, a vertical direction is shown in an arrow.

The printer 10 includes a charging unit 30, an exposing unit 40, a developing rotary unit 50, a primary transfer unit 60, an intermediate transfer member 70 and a cleaning blade 76 in the rotation direction of a photosensitive unit 20 as a latent image carrier for carrying a latent image, and furthermore, a secondary transfer unit 80, a fixing unit 90, a display unit 95 constituted by a liquid crystal panel for reporting a notice to a user, and a control unit 100 for controlling each of these units and controlling the operation of the printer 10. The control unit 100 will be described below.

The photosensitive unit 20 has a cylindrical conductive base material and a photosensitive layer formed on an outer peripheral surface thereof and can be rotated around a central axis, and is assumed to be rotated clockwise as shown in an arrow of FIG. 1.

The charging unit 30 is a device for charging the photosensitive member 20, and the exposing unit 40 is a device for forming a latent image on the photosensitive member 20 charged by irradiating a laser. The exposing unit 40 has a semiconductor laser, a polygon mirror and an F-θ lens, and irradiates a modulated laser onto the charged photosensitive member 20 based on an image signal input from the control unit 100.

The developing rotary unit 50 has a rotary 55 to be a rotor and four cartridges attached to the rotary 55. The rotary 55 is rotatable around a rotating shaft 50a, and four cartridges 51, 52, 53 and 54 can be attached and removed through a cartridge exchange port which will be described below, respectively.

Moreover, a cartridge memory for storing identification information including information about a lifetime such as the amount of a residual toner is provided in each of the predetermined portions of the cartridges 51, 52, 53 and 54, which is not shown in FIG. 1. The control unit 100 can communicate with each of the cartridge memories by wireless through an antenna 124 provided in the predetermined portion of the printer 10. It is desirable that the cartridge memory should be a nonvolatile memory capable of saving the data also in a state in which a power supply is OFF or the printer 10 is removed. An EEPROM or a ferroelectric memory (Ferroelectric RAM) such as a flash memory can be employed for the nonvolatile memory.

The primary transfer unit 60 is a device for transferring a monochromatic toner image formed on the photosensitive member 20 onto the intermediate transfer member 70, and a full color toner image is formed on the intermediate transfer member 70 when toners having four colors are sequentially superposed and transferred.

The intermediate transfer member 70 is an endless belt and is rotated and driven at an almost equal peripheral speed to the speed of the photosensitive unit 20. A reading sensor RS for synchronization is provided in the vicinity of the intermediate transfer member 70. The reading sensor RS for synchronization serves to detect the reference position of the intermediate transfer member 70, and obtains a synchronizing signal Vsync in a secondary scanning direction which is orthogonal to a primary scanning direction. The reading sensor RS for synchronization has a light emitting unit for emitting a light and a light receiving unit for receiving a light. When the light emitted from the light emitting unit passes through a hole formed in the predetermined position of the intermediate transfer member 70 and is received by the light receiving unit, the reading sensor RS for synchronization generates a pulse signal. One pulse signal is generated every time the intermediate transfer member 70 carries out a rotation.

The secondary transfer unit 80 is a device for transferring a monochromatic toner image or a full color toner image formed on the intermediate transfer member 70 onto a recording medium such as a paper, a film or a cloth.

The fixing unit 90 is a device for fusing the monochromatic toner image or the full color toner image transferred onto the recording medium to the recording medium such as a paper, thereby forming a permanent image.

The cleaning blade 76 is formed of rubber and abuts on the surface of the photosensitive member 20. The cleaning blade 76 scrapes off and removes the toner remaining on the photosensitive member 20 after a toner image is transferred onto the intermediate transfer member 70 by the primary transfer unit 60.

A photosensitive unit 75 is provided between the primary transfer unit 60 and the exposing unit 40, and has the photosensitive member 20, the charging unit 30, the cleaning blade 76, and a waste toner housing portion for accommodating the toner scraped off by the cleaning blade 76.

Next, the operation of the printer 10 thus constituted will be schematically described. First of all, when an instruction for printing is given, the photosensitive member 20 and the intermediate transfer member 70 are rotated by the control of the control unit 100. Then, the reference position of the intermediate transfer member 70 is detected by the reading sensor RS for synchronization so that a pulse signal is output. The pulse signal is transmitted to the control unit 100. Thereafter, the control unit 100 controls the following operation on the basis of the pulse signal which is received.

The photosensitive member 20 is sequentially charged by the charging unit 30 in a charging position with a rotation. The region of the photosensitive member 20 which is charged reaches an exposing position with the rotation of the photosensitive member 20 so that a latent image corresponding to image information for a first color, for example, yellow Y is formed in the same region by the exposing unit 40. The latent image formed on the photosensitive member 20 reaches a developing position with the rotation of the photosensitive member 20. At this time, the rotary 55 is rotated by the control of the control unit so that a cartridge for yellow is moved to an opposed position to the photosensitive member 20 and a development is carried out in a yellow toner by the cartridge for yellow. Consequently, a yellow toner image is formed on the photosensitive member 20.

The yellow toner image formed on the photosensitive member 20 reaches the primary transfer position with the rotation of the photosensitive member 20 and is transferred onto the intermediate transfer member 70 by the primary transfer unit 60. In this case, a primary transfer voltage having a reverse polarity to the charging polarity of the toner is applied to the primary transfer unit 60. In the meantime, the secondary transfer unit 80 is separated from the intermediate transfer member 70.

The processing is repetitively executed for second, third and fourth colors so that a toner image for each color corresponding to each image signal is superposed on the intermediate transfer member 70 and is thus transferred. Consequently, a full color toner image is formed on the intermediate transfer member 70.

The full color toner image formed on the intermediate transfer member 70 reaches a secondary transfer position with the rotation of the intermediate transfer member 70, and is transferred onto the recording medium by the secondary transfer unit 80. The recording medium is delivered from a paper feed tray 92 to the secondary transfer unit 80 through a paper feed roller 94 and a registration roller 96. When a transfer operation is to be carried out, moreover, the secondary transfer unit 80 is pressed against the intermediate transfer member 70, and furthermore, a second transfer voltage is applied.

The full color toner image transferred onto the recording medium is heated and pressurized by the fixing unit 90 and is fused to the recording medium. On the other hand, the photosensitive member 20 passes through the primary transfer position and a toner stuck to a surface is then scraped off by the cleaning blade 76 to prepare for charging in order to form a next latent image. The toner thus scraped off is collected into the waste toner housing portion.

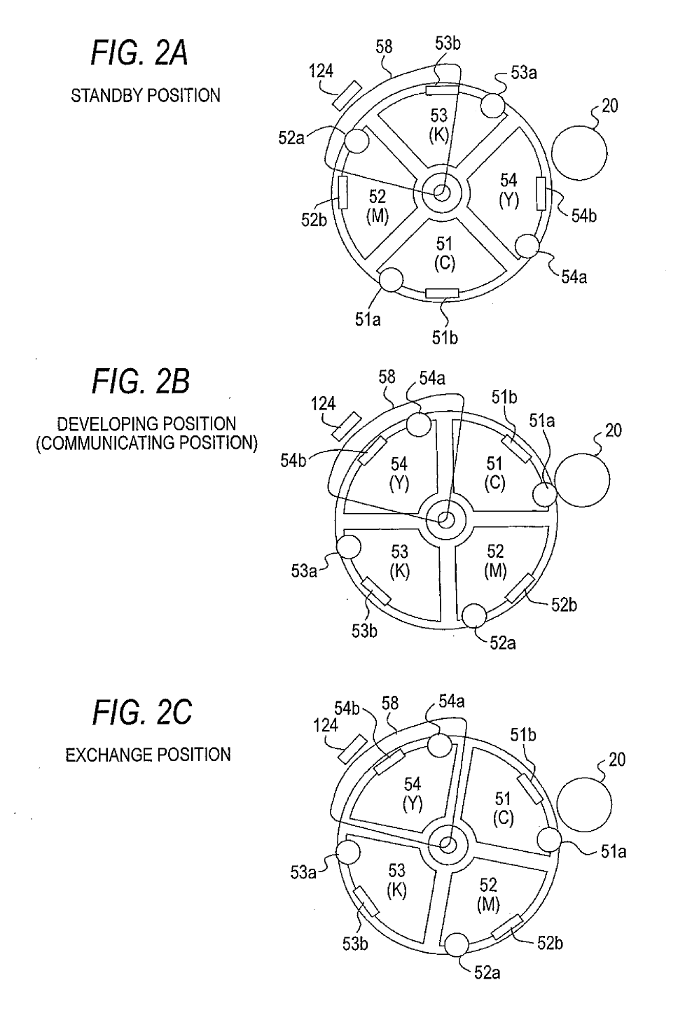

Next, description will be given to the stop position of the developing rotary unit 50. FIGS. 2A to 2C are typical views showing the stop position of the developing rotary unit 50. In FIGS. 2A to 2C, 58 denotes a cartridge exchange port, 51a, 52a, 53a and 54a denote developing rollers for the cartridges 51, 52, 53 and 54 respectively, and 51b, 52b, 53b and 54b denote cartridge memories for the cartridges 51, 52, 53 and 54 respectively. In the following description, it will be assumed that the cartridges 51, 52, 53 and 54 accommodate toners for C, M, K and Y, respectively.

The developing rotary unit 50 is rotated and driven in an opposite direction to the photosensitive member 20, in this case, counterclockwise by the control of the control unit 100. Three kinds of positions, that is, a standby position, a developing position (a communicating position) and a removing position are determined. The standby position is a position determined in a standby state in which the printer does not carry out an image forming operation, and a position in which the developing rollers of all of the cartridges are maintained to be separated from the photosensitive member 20, and furthermore, any of the cartridges cannot be taken out through the cartridge exchange port 58 as shown in FIG. 2A.

Moreover, the developing position is determined when an electrostatic latent image on the photosensitive member 20 is to be formed with a selected toner color. As shown in FIG. 2B, the developing roller of one of the cartridges (in the example of FIG. 2B, the developing roller 51a provided in the cartridge 51) is opposed to the photosensitive member 20 and a predetermined developing bias is applied so that the electrostatic latent image is formed with a toner. Also in the developing position, any of the cartridges cannot be taken out through the cartridge exchange port 58.

The developing position also serves as a communicating position for the other cartridges. The cartridge memories 51b, 52b, 53b and 54b are provided on the ends of the surfaces of the cartridges 51, 52, 53 and 54, respectively. As described above, the cartridge memories 51b, 52b, 53b and 54b store identification information including information about the lifetime of the cartridge such as the amount of a residual toner.

When the developing rotary unit 50 is placed in the developing position as shown in FIG. 2B, the cartridge memory of one of the cartridges other than the cartridge placed in the developing position (the cartridge memory 54b of the cartridge 54 in the example of FIG. 2B) is placed in an opposite position to the antenna 124 provided in the printer 10 body and the communication of the control unit 100 with the cartridge memory can be carried out through the antenna 124. In FIG. 2B, a first counterclockwise one of the cartridges placed in the developing position, that is, a cartridge for a color developed immediately before a color which is being developed is placed in the communicating position. This implies that the developing position is placed in the communicating position for the other cartridges.

In other words, a positional relationship among the cartridge memory of each of the cartridges, the photosensitive member 20 and the antenna 124 is determined in such a manner that the developing position is set to be the communicating position.

In the state shown in FIG. 2B, accordingly, the development of the color of cyan C is carried out with respect to the photosensitive member 20 by the developing roller 51a of the cartridge 51, while the control unit 100 can write the current identification information to the cartridge memory 54b of the cartridge 54. With this structure, thus, the current identification information can be written to the cartridge memory of the cartridge for a color developed immediately before a color which is being developed.

Next, the exchange position will be described. The exchange position can be taken only when an operation for attaching and removing the cartridge is carried out. When the developing rotary unit 50 is placed in the exchange position, one of the cartridges appears in the cartridge exchange port 58 as shown in FIG. 2C and can be taken out through the cartridge exchange port 58. FIG. 2C shows a state in which the cartridge 54 for yellow appears in the cartridge exchange port 58. Moreover, a cartridge can be newly attached through the cartridge exchange port 58. In the exchange position, the developing rollers provided in all of the cartridges are placed in positions set apart from the photosensitive member 20. Thus, it is possible to take out only one cartridge appearing in the cartridge exchange port 58 when the developing rotary unit 50 is placed in the exchange position. Therefore, a user can be prevented from damaging the apparatus due to the careless attachment and removal of the cartridge.

Moreover, a home position sensor 106 (a home position will be hereinafter referred to as HP) for detecting the home position of the developing rotary unit 50 is provided in the printer 10, which is not shown in FIGS. 1 and 2.

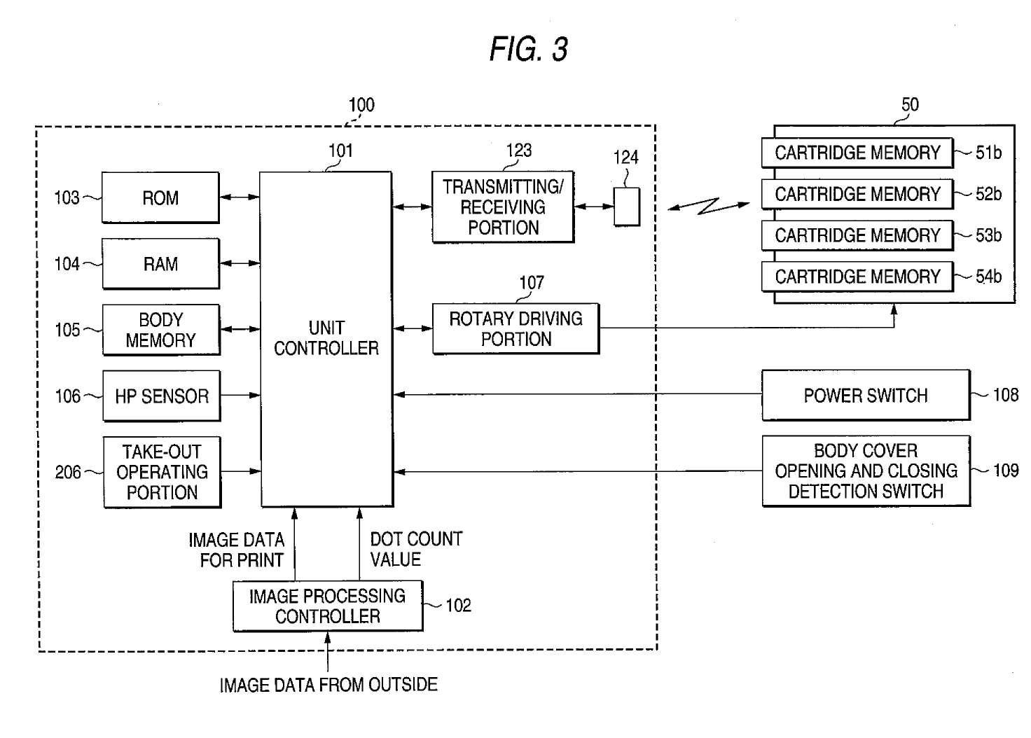

With reference to FIG. 3, the electrical structure of the printer 10 will be explained. FIG. 3 shows a block structure according to the invention. Since a block for controlling the photosensitive unit 75 and a block for controlling the exposing unit 40 are not essential matters in the invention, they are not shown.

The control unit 100 includes two controllers, that is, a unit controller 101 and an image processing controller 102. Both of these two controllers 101 and 102 have a CPU respectively.

The image processing controller 102 has the function of receiving various data such as image data created by the application software of an external computer system such as a personal computer (not shown) and converting RGB data on red, green and blue to be image data into YMCK data on yellow, magenta, cyan and black to create image data for print. Moreover, the image processing controller 102 has the function of counting a dot count value for each of the colors YMCK based on the image data for print on the YMCK which are thus created. Then, the image processing controller 102 transfers the image data for print on the colors YMCK and the dot count value for each color image of YMCK to the unit controller 101. The dot count value indicates the number of dots to be formed on a recording paper when printing is carried out as is well known.

The unit controller 101 controls each of the charging unit 30, the exposing unit 40, the primary transfer unit 60, the photosensitive unit 75, the secondary transfer unit 80, the fixing unit 90 and the display unit 95, and controls the developing rotary unit 50 based on various signals such as image data for print which are input from the image processing controller 102. In FIG. 3, a rotary driving portion 107 is shown as a component for driving the developing rotary unit 50. The developing rotary unit 50 is driven by a stepping motor.

The unit controller 101 manages three memories, that is, an ROM 103, an RAM 104 and a body memory 105. The ROM 103 stores various programs for controlling the printer 10, and the RAM 104 serves to temporarily store various information about the printer 10 and is used as a work memory. The body memory 105 will be described later.

Also, the unit controller 101 receives a signal from a take-out operating portion 206. The take-out operating portion 206 serves to select a cartridge to be taken out of the developing rotary unit 50.

Moreover, a detection signal is input from the HP sensor 106 to the unit controller 101. Furthermore, the unit controller 101 monitors the state of a power switch (not shown in FIGS. 1 and 2) 108 and a body cover opening and closing detection switch (not shown in FIGS. 1 and 2) 109, and detects the ON operation of a power supply if any and detects the opening and closing operation of the body cover (not shown in FIGS. 1 and 2) if any.

Furthermore, the unit controller 101 can communicate with the cartridge memories 51b, 52b, 53b and 54b provided in the cartridges 51, 52, 53 and 54 attached to the developing rotary unit 50 through a transmitting/receiving portion 123 and the body side antenna 124 by wireless. The transmitting/receiving portion 123 has the function of modulating data transmitted from the unit controller 101 and demodulating data received from the cartridge memory. As described above, the cartridge memory which can communicate with the unit controller 101 is placed in the communicating position.

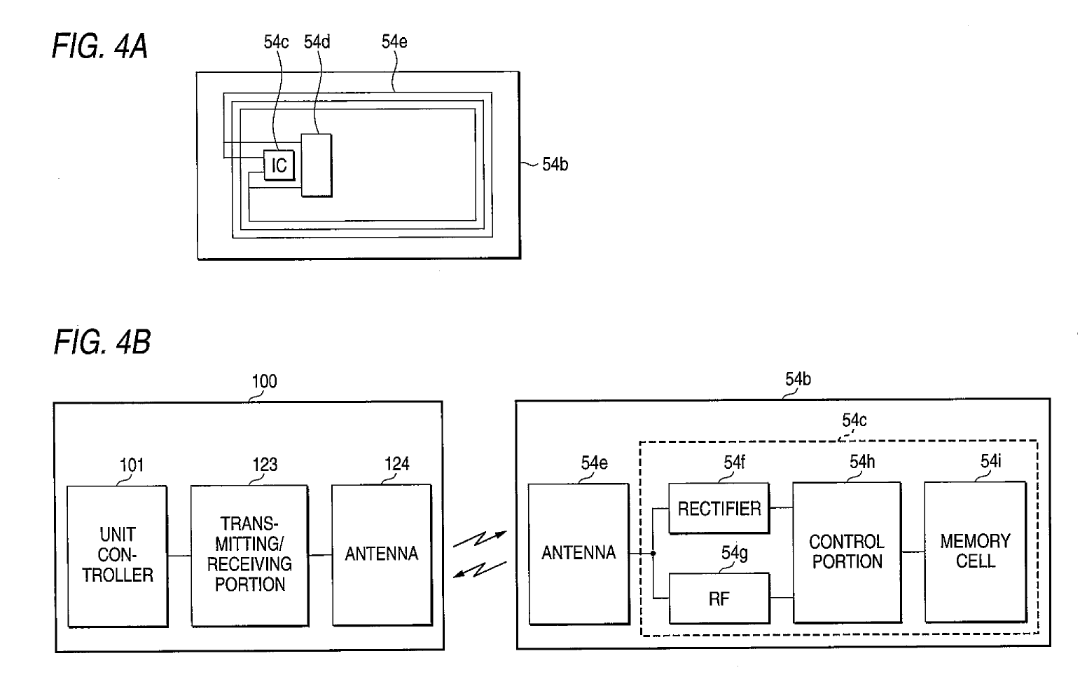

With reference to FIGS. 4A and 4B, the structure of the cartridge memory will be described including the transmitting and receiving structure of the data. FIG. 4A is a perspective plan view showing the structure of the cartridge memory 54b, and FIG. 4B is a block diagram for explaining the internal structures of the cartridge memory and the transmitting/receiving portion. Description will be given to the cartridge memory 54b provided in the cartridge 54 for yellow, and can also be applied to the other cartridge memories 51b, 52b and 53b.

If a predetermined positional relationship between the cartridge memory 54b and the body side antenna 124, for example, a mutual distance is less than 10 mm, information can be transmitted and received in a non-contact state with each other. The cartridge memory 54b wholly has a very small size and thickness, and can also be stuck as a seal to an object with either side having an adhesiveness. The cartridge memory 54b is referred to as a memory tag and various types have been put on the market.

The cartridge memory 54b has a planar coil to be a non-contact IC chip 54c, a capacitor 54d for resonance which is formed by etching a metal coat and an antenna 54e, and these are mounted on a plastic film and are covered with a transparent cover sheet.

The non-contact IC chip 54c has a rectifier 54f, a signal analyzing portion RF (Radio Frequency) 54g, a control portion 54h and a memory cell 54i. The memory cell 54i is a nonvolatile memory capable of carrying out electrical read/write, for example, an NAND type flash ROM, and can store written information and can read stored information from an outside.

The antenna 54e of the cartridge memory 54b and the body side antenna 124 communicate with each other by wireless, and read information stored in the memory cell 54i and write information to the memory cell 54i. Moreover, a high frequency signal generated in the transmitting/receiving portion 123 of the control unit 100 is induced as a high frequency magnetic field through the body side antenna 124. The high frequency magnetic field is absorbed through the antenna 54e of the cartridge memory 54b and is rectified by the rectifier 54f, and thus becomes a DC power supply for driving each circuit in the IC chip 54c.

The identification information including information about the lifetime of the cartridge such as the amount of a residual toner is stored in the memory cell 54i of the cartridge memory 54b, and is updated by the unit controller 101 every time a predetermined event is generated.

The body memory 105 serves to store identification information about the cartridges 51, 52, 53 and 54 attached to the developing rotary unit 50. It is desirable that the body memory 105 should be a nonvolatile memory capable of saving data also when the power supply of the printer 10 is OFF.

The unit controller 101 carries out an operation for reading the identification information from the cartridge memory of each cartridge and writing the same identification information to the body memory 1051 then updating the information about the lifetime of the cartridge, for example, the amount of a residual toner in each cartridge, a driving time or the number of sheets to be printed every time a development is performed, and communicating with the cartridge memory to write the current identification information to the cartridge memory when a predetermined event is generated.

Further, the unit controller 101 carries out an operation for communicating with the cartridge memory of the cartridge when a new cartridge is attached to the developing rotary unit 50, reading the identification information stored in the cartridge memory, and storing the same identification information in the body memory 1051 and then updating the information about the lifetime of the cartridge, for example, the amount of a residual toner in each cartridge, a driving time or the number of sheets to be printed every time a development is performed, and communicating with the cartridge memory to write the current identification information to the cartridge memory when a predetermined event is generated, for example.

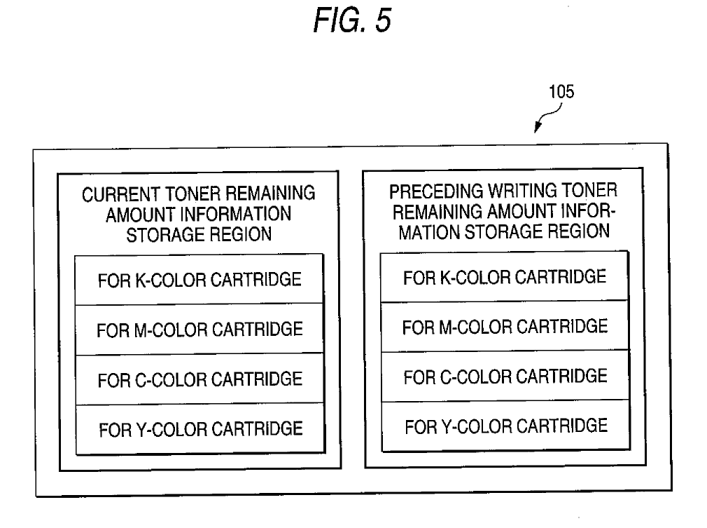

The body memory 105 stores the identification information about the cartridges 51, 52, 53 and 54 attached to the developing rotary unit 50 and the information about the lifetime, for example, the amount of the residual toner is updated by the unit controller 101 every time the development is carried out as described above. In particular, two storage regions including the current toner remaining amount information storage region (hereinafter referred to as the current toner region) and a preceding writing toner remaining amount information storage region (hereinafter referred to as a preceding writing region) are allocated to a region for storing the information about the amount of the residual toner in each cartridge as shown in FIG. 5. These two storage regions are provided with regions for the four cartridges 51, 52, 53 and 54, respectively.

A region for a cartridge for each color in the preceding writing region is a region for storing the information about the amount of the residual toner which is written to the respective cartridge memories when a close event to update the identification information is generated, more specifically, the memory cell of the cartridge memory. When printing is carried out, then, a toner having a color used in the printing is decreased. In that case, the unit controller 101 calculates the amount of the used toner for each color in the printing based on the dot count value transmitted from the image processing controller 102, and furthermore, calculates the amount of the residual toner after the printing at this time. The current toner remaining amount is thus obtained and a region for storing the current toner remaining amount is the current toner region.

For the calculation to obtain the current toner remaining amount, for example, it is preferable to decrease the amount of the toner used at this time from the amount of the residual toner which is stored in the preceding writing region. Moreover, there have been known various methods of calculating the amount of the used toner based on the dot count value. It is preferable that any of the well-known methods should be used.

Referring to the region for storing the information about the amount of the residual toner in each cartridge of the body memory 105, since the two storage regions, that is, the current toner region and the preceding writing region are provided, it is possible to immediately decide whether or not the current identification information, particularly, the current amount of a residual toner is written to the cartridge memory of a certain cartridge when an instruction for taking out the same cartridge is given by a user as is apparent from the following description. Further, it is possible to determines that whether the cartridge is actually exchanged or not.

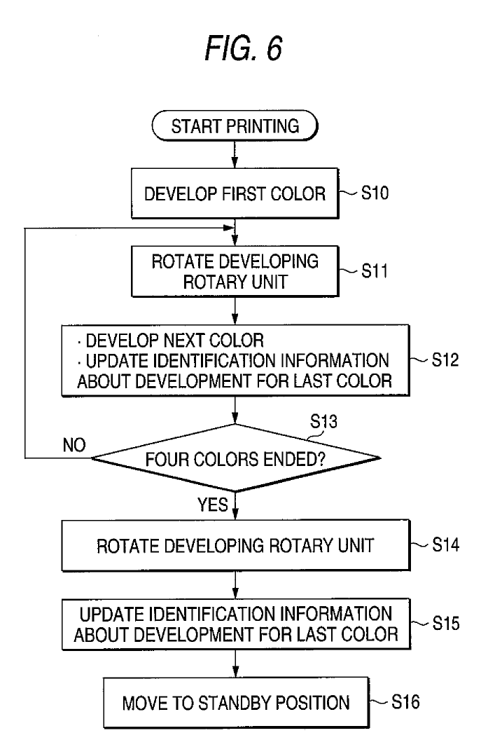

Next, an operation for writing the identification information to the cartridge memory will be mainly described schematically with reference to FIG. 6. FIG. 6 is a flowchart showing the processing of the unit controller 101 in the printing, in which it is assumed that an event in which the identification information of the cartridge memory is to be updated is a development. More specifically, it is assumed that the identification information of the cartridge memory is updated every time the development is carried out.

Upon receipt of image data for print and a print start signal from the image processing controller 102, the unit controller 101 places a cartridge for a first color in the developing position by the rotary driving portion 107 and a development for the first color is thus carried out (Step S10). When the development of the first color is ended, the unit controller 101 rotates the developing rotary unit 50 by the rotary driving portion 107 (Step S11), and places a cartridge for a next color, in this case, a second color in the developing position. At this time, a cartridge for a last color, in this case, the first color is placed in the communicating position as shown in FIG. 2B. In this state, accordingly, the unit controller 101 develops the second color, and furthermore, communicates with the cartridge memory of the cartridge for the last color to read the current identification information about the cartridge from the body memory 105 and to write the identification information to the cartridge memory (Step S12). Consequently, the identification information of the cartridge memory is updated to be the current. This is a processing of updating the identification information about the development of the last color which is described in the Step S12. As a matter of course, the identification information also includes information about a lifetime such as the amount of a residual toner and a driving time.

When the development of a third color and the update of the identification information in the cartridge memory of the cartridge for the second color, and the development of a fourth color and the update of the identification information in the cartridge memory of the cartridge for the third color are ended in the same manner, a decision at Step S13 is yes and the unit controller 101 rotates the developing rotary unit 50 by the rotary driving portion 107 (Step S14) to carry out a processing of updating the identification information about the development of the last color (Step S15). More specifically, in this case, the cartridge carrying out the development for the fourth color is placed in the communicating position to write the current identification information to the cartridge memory of the same cartridge. The unit controller 101 places the developing rotary unit 50 in the standby position (Step S16) and the processing is thus ended.

While the number of sheets to be printed is one in the above description, it is preferable that a first color on a first page should be developed at the Step S10 and the processings of the Steps S11 to S13 should be then repeated corresponding to the number of sheets to be printed in the case that a plurality of sheets are to be printed.

Referring to the amount of the residual toner in each cartridge, the body memory 105 includes the two storage regions having the current toner region and the preceding writing region as described above. Description will be given to the way of using information about the amount of the residual toner in these two storage regions in the update of the identification information about the cartridge memory of the cartridge for the last color at the Steps S12 and S15 in FIG. 6. Herein, only the amount of the residual toner will be described.

Assuming that a certain color (that is, a Y color) is developed, for example, the unit controller 101 calculates the amount of the residual toner in the cartridge for the Y color after the present development based on the dot count value of the Y color transmitted from the image processing controller 102. This is the current toner remaining amount, and the unit controller 101 first writes information about the current toner remaining amount in a region for the Y-color cartridge in the current toner region of the body memory 105. At this time, information about the region for the Y-color cartridge in the preceding writing region is not changed.

Subsequently, a next color is developed. At this time, the Y-color cartridge is placed in the communicating position. Therefore, the unit controller 101 communicates with the cartridge memory for the Y-color cartridge to read information about the amount of the residual toner from the region for the Y-color cartridge in the current toner region of the body memory 105 and to write the same information to the cartridge memory of the Y-color cartridge, and then, writes the same information to the region for the Y-color cartridge in the preceding writing region and to update the information about the amount of the residual toner in the region for the Y-color cartridge in the preceding writing region.

Referring to the update of the amount of the residual toner in the update of the identification information in the cartridge memory of the cartridge for the last color at the Steps S12 and S15 in FIG. 6, the above operation is repeated.

From the foregoing, referring to the cartridge for a certain color, in the case that the information about the amount of the residual toner which is written to the region for the cartridge of the same color in the current toner region and the information about the amount of the residual toner which is written to the region for the cartridge of the same color in the preceding writing region in the body memory 105 are coincident with each other, it is supposed that the current identification information is written to the cartridge memory.

Also in some cases in which the identification information of the cartridge memory is to be updated every time the development is carried out as described above, however, the information about the amount of the residual toner written to the region for the cartridge of a certain color in the current toner region and the information about the amount of the residual toner written to the region for the cartridge of the same color in the preceding writing region in the body memory 105 are not coincident with each other. Description will be given.

In order to write the current amount of the residual toner, that is, the amount of the residual toner after the last development to the cartridge memory of a cartridge for a last developed color at the Step S12 or S15 in FIG. 6, the calculation of the current amount of the residual toner based on the dot count value transmitted from the image processing controller 102 and the write of the current amount of the residual toner to the region for the cartridge of the same color in the current toner region of the body memory 105 are to be ended before a writing timing is reached.

However, a timing in which the dot count value is transmitted from the image processing controller 102 to the unit controller 101 is not constant. In some cases, the timing in which the dot count value is transmitted to the unit controller 101 is delayed for some cause, for example, the amount of the processing of the image processing controller 102 is large at that time, and the current amount of the residual toner cannot be written to the region for the cartridge of the same color in the current toner region of the body memory 105 before a timing for write to the cartridge memory is reached.

In these cases, the unit controller 101 writes, to the cartridge memory for the same color, the information about the amount of the residual toner which is written to the current toner region of the body memory 105 when the identification information of the same cartridge memory is to be updated.

After the identification information of the cartridge memory is updated, the unit controller 101 obtains information about the current amount of the residual toner based on the dot count value for the same color which is transmitted from the image processing controller 102 and writes the information about the current amount of the residual toner to the region for the cartridge of the same color in the current toner region of the body memory 105. At this time, any processing is not carried out over the region for the cartridge of the same color in the preceding writing region. At this point, accordingly, the information about the current toner region and the information about the preceding writing region for the same color are not coincident with each other.

For example, the cartridge for the Y color will be considered. It is assumed that both the information about the amount of the residual toner in the region for the cartridge of the Y color in the current toner region and the information about the amount of the residual toner in the region for the cartridge of the Y color in the preceding writing region in the body memory 105 are represented by A before the development of the Y color. Accordingly, it is supposed that the information about the current amount of the residual toner is written to the cartridge memory of the Y-color cartridge before the development.

Assuming that the transmission of the dot count value for the Y color from the image processing controller 102 is delayed after the development of the Y color and the current amount of the residual toner after the development of the Y color cannot be written to the region for the cartridge of the Y color in the current toner region of the body memory 105 before the timing for write to the cartridge memory of the Y-color cartridge is reached, however, information about the amount of the residual toner which is to be written to the cartridge memory of the Y-color cartridge at this time is represented by A written to the region for the cartridge of the Y color in the current toner region of the body memory 105.

When the write to the cartridge memory is ended, then, the unit controller 101 writes A to the region for the cartridge of the Y color in the preceding writing region of the body memory 105. After the identification information of the cartridge memory for the Y color is updated, subsequently, the unit controller 101 obtains the information about the current amount of the residual toner in the Y-color cartridge after a last development based on the dot count value of the Y color which is transmitted from the image processing controller 102. In case of A′ (<A), the unit controller 101 writes the current toner remaining amount information A′ to the region for the cartridge of the Y color in the current toner region of the body memory 105. At this time, any processing is not carried out over the region for the cartridge of the Y color in the preceding writing region. For this reason, the information about the amount of the residual toner in the region for the cartridge of the Y color in the preceding writing region is maintained to be A.

In other words, at this point, the information about the amount of the residual toner which is written to the cartridge memory of the Y-color cartridge is A and the information about the amount of the residual toner which is written to the region for the cartridge of the Y color in the current toner region of the body memory 105 is A′, and the information about the amount of the residual toner which is written to the region for the cartridge of the Y color in the preceding writing region is A.

From the above description, it is found that the current identification information is not written to a cartridge for a certain color in the case that the information about the amount of the residual toner which is written to the region for the cartridge of the same color in the current toner region and the information about the amount of the residual toner which is written to the region for the cartridge of the same color in the preceding writing region of the body memory 105 are not coincident with each other.

The information about the lifetime in the identification information about the cartridge includes information about a driving time and the number of sheets to be printed in addition to the amount of the residual toner. The information about the lifetime other than the amount of the residual toner is always updated to the current information in the update of the identification information in the Steps S12 and S15 of FIG. 6. The reason is as follows. The information about the lifetime other than the amount of the residual toner, for example, the driving time and the number of sheets to be printed can be directly counted by the unit controller 101. Therefore, the same information can be written to a predetermined region for the cartridge of the same color in the body memory 105 before the timing for the write to the cartridge memory is reached after the development.

Thus, the information about the amount of the residual toner in the information about the lifetime of the cartridge can be obtained based on the dot count value transmitted from the image processing controller 102, while the other information about the lifetime can be directly counted by the unit controller 101. In this respect, the information about the amount of the residual toner is different from the other information about the lifetime in some situation.

Based on the above structure, description will be given to four embodiments on a peculiar operation to the invention. All of the embodiments which will be described below are carried out when the unit controller 101 detects that a power supply is turned ON or detects that the body cover of the printer body 10 is closed.

More specifically, as described above, in the case that the carriage is exchanged when the control unit of the body cannot recognize that the cartridge is exchanged, for example, when the cover of the body is opened during the rotation of the developing rotary unit or the power supply is turned OFF, the invention can carry out the accurate lifetime management for the cartridge. Accordingly, it is preferable to cause the identification information of the body memory 105 to be coincident with the identification information of the cartridge memory when the body cover is closed or the power supply is turned ON. Therefore, the unit controller 101 executes a processing which will be described below when detecting that the power supply is turned ON or detecting that the body cover of the printer body 10 is closed.

### First Embodiment

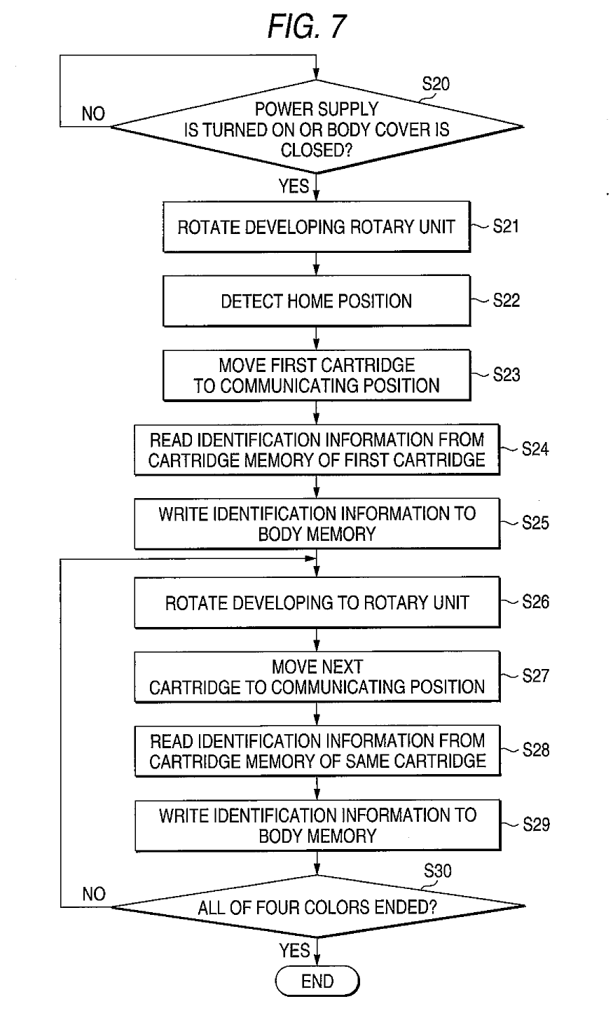

FIG. 7 is a flowchart showing a processing in a first embodiment according to the invention. When detecting that the power supply is turned ON by turning on the power switch 108 or detecting that the body cover is closed in accordance with the state of the body cover opening and closing detection switch 109 (in the case that a decision at Step S20 is yes), the unit controller 101 controls the rotary driving portion 107 to rotate the developing rotary unit 50 (Step S21). When a detection signal is received from the HP sensor 106, then, HP is detected (Step S22). When detecting the HP, the unit controller 101 controls the rotary driving portion 107 to move the first cartridge to the communicating position (Step S23). Any of the four cartridges 51, 52, 53 and 54 which is to be a first cartridge is predetermined by the unit controller 101.

Consequently, the communication of the unit controller 101 with the cartridge memory of the first cartridge can be carried out. Therefore, the unit controller 101 communicates with the cartridge memory to read all of identification information written to the cartridge memory (Step S24). When reading the identification information from the cartridge memory, the unit controller 101 writes all of the identification information thus read to a region for writing the identification information about the first cartridge in the body memory 105 (Step S25). Information about the amount of a residual toner which is read from the cartridge memory is written to both the current toner region for the color of the first cartridge and the preceding writing region.

Consequently, all of the identification information about the first cartridge in the body memory 105 are updated and are set to have the same contents as those regions of the cartridge memory in the first cartridge.

When the identification information about the first cartridge in the body memory 105 is updated, thus, the unit controller 101 subsequently controls the rotary driving portion 107 to rotate the developing rotary unit 50 (Step S26), thereby moving a next cartridge, that is, a cartridge for a second color to the communicating position (Step S27).

Consequently, the communication of the unit controller 101 with the cartridge memory of the cartridge for the second color can be carried out. Therefore, the unit controller 101 communicates with the cartridge memory to read the identification information written to the cartridge memory (Step S28).

When reading the identification information from the cartridge memory, the unit controller 101 writes the identification information thus read to a region for writing the identification information about the cartridge for the second color (Step S29). Similarly, the information about the amount of the residual toner which is read from the cartridge memory is written to both the current toner region for the color of the cartridge and the preceding writing region.

When the above processing is carried out over a cartridge for a third color and a cartridge for a fourth color, a decision at Step S30 is yes. Therefore, the unit controller 101 ends the processing.

As described above, the first embodiment is based on a thought that the abnormal exchange of the cartridge is carried out irrespective of a decision whether the abnormal exchange of the cartridge is actually carried out. In the case that the power supply is turned ON or the body cover is closed, the identification information about the cartridge for each color in the body memory 105 is forcibly updated with the identification information read from the cartridge memory. Also in the case that the cartridge is exchanged when the unit controller 101 cannot recognize that the cartridge is exchanged, for example, when the body cover is opened during the rotation of the developing rotary unit 50 or the power supply is turned OFF, therefore, it is possible to carry out an accurate lifetime management for the cartridge.

### Second Embodiment

According to the processing in the first embodiment, the identification information about the cartridge for each color in the body memory 105 is forcibly updated with the identification information read from the cartridge memory of the cartridge for each color and the contents of the information about the amount of the residual toner in both the current toner region and the preceding writing region in the region of the body memory 105 for storing the information about the amount of the residual toner in each cartridge are also updated to the information about the amount of the residual toner which is read from the cartridge memory.

As described above, however, the information about the amount of the residual toner which is written to the cartridge memory is not always corresponded to the current information about the amount of the residual toner which is written to the current toner region of the body memory 105. According to the first embodiment, a situation in which the contents of the current toner region in the body memory 105 are updated to old information about the amount of the residual toner is occurred as follows in some cases.

For easy understanding, it is assumed that the abnormal exchange of the cartridge is not carried out but ending is performed in a normal state and a power supply is turned OFF. At this time, referring to a certain cartridge, there is a possibility that the transmission of a dot count value for the color from the image processing controller 102 might be delayed in the update of identification information after a last development before the power supply is turned OFF, and the current amount of the residual toner cannot be written to the region for the cartridge of the same color in the current toner region of the body memory 105 before a timing for write to the cartridge memory is reached. In this case, the information about the amount of the residual toner which is written to the cartridge memory is equivalent to information written to the preceding writing region.

According to the first embodiment, when the power supply is turned ON in such a state, both of the contents in the current toner region for the same color in the body memory 105 and the preceding writing region are rewritten to the information about the amount of the residual toner which is read from the cartridge memory and are thus updated. For this reason, the information about the amount of the residual toner which is written to the current toner region at this time is the old information about the amount of the residual toner, which is not correct.

In other words, in such a case, there is a possibility that a slight error might be made between the amount of the residual toner which is managed by the body memory 105 and the actual amount of the residual toner in the cartridge. When such a situation is repeated many times, the error between the amount of the residual toner which is managed by the body memory 105 and the actual amount of the residual toner is increased.

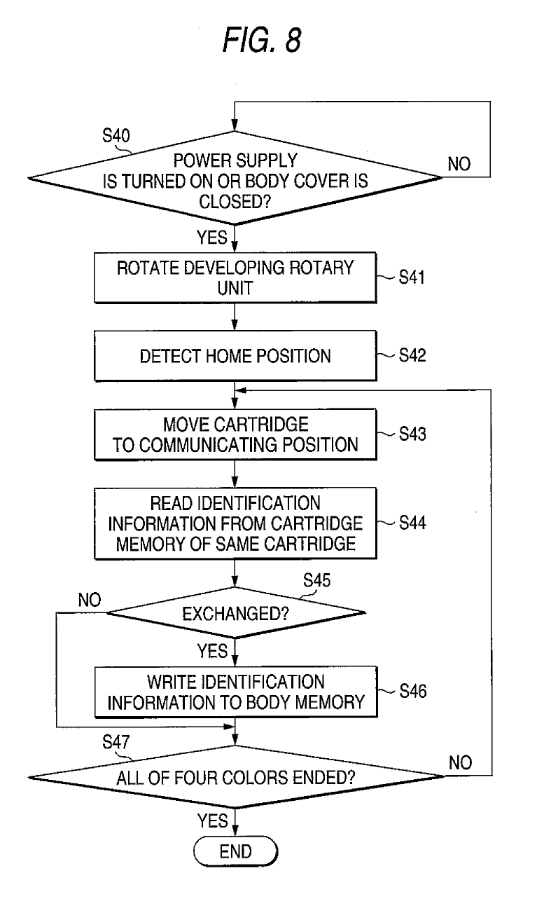

The second embodiment serves to avoid such a situation and will be described below with reference to a flowchart shown in FIG. 8. When detecting that the power switch 108 is turned ON so that the power supply is thus turned ON or detecting that the body cover is closed depending on the state of the body cover opening and closing detection switch 109 (in the case that a decision at Step S40 is yes), the unit controller 101 controls the rotary driving portion 107 to rotate the developing rotary unit 50 (Step S41). When a detection signal is received from the HP sensor 106, HP is detected (Step S42).

When detecting the HP, the unit controller 101 controls the rotary driving portion 107 to first move one cartridge to the communicating position (Step S43). Any color for the cartridge to be moved to the communicating position at this time is predetermined by the unit controller 101.

Consequently, the communication of the unit controller 101 with the cartridge memory of the first cartridge can be carried out. Therefore, the unit controller 101 communicates with the cartridge memory to read all of identification information written to the cartridge memory (Step S44). The reason why all of the identification information are read is that the cartridge might be exchanged and all of the identification information about the cartridge in the body memory 105 are to be updated when the cartridge has been exchanged.

When reading the identification information from the cartridge memory, the unit controller 101 decides whether the cartridge has actually been exchanged or not (Step S45).

Whether the cartridge has been exchanged is decided at the Step S45 by comparing the identification information read from the cartridge memory at the Step S44 with the identification information written corresponding to the cartridge for the same color in the body memory 105. For information to be used for making the comparison, it is necessary to utilize information capable of making a clear distinction from another cartridge for the same color. For this purpose, it is preferable to use the information about a lifetime which is the characteristic information about each cartridge in the identification information.

While the information about a lifetime includes information about the amount of a residual toner, a driving time and the number of sheets to be printed, it is preferable to use the information about the amount of the residual toner in order to decide whether the cartridge has been exchanged or not at the Step S45. The reason is as follows. Although the amount of consumption of a toner in a development is very small, a difference in the amount of consumption of a toner in the development can also be expressed as the information about the amount of the residual toner. For this purpose, a greater bit count than a bit count for expressing the driving time or the number of sheets to be printed is allocated. By using the information about the amount of the residual toner, thus, it is possible to decide whether the cartridge has been exchanged or not at the Step S45 with high precision.

The information about the amount of the residual toner which is written corresponding to the cartridge for the first color in the body memory 105 includes two sorts of information about the amount of the residual toner, that is, the amount of a residual toner which is written to the current toner region and the amount of a residual toner which is written to a preceding writing region. In the case that the information about the amount of the residual toner in the identification information read from the first cartridge memory at the Step S44 is coincident with either the information about the amount of the residual toner which is written to the current toner region or the information about the amount of the residual toner which is written to the preceding writing region, it is decided that the first cartridge has not been exchanged. In the case that the information about the amount of the residual toner in the identification information is coincident with neither the information about the amount of the residual toner which is written to the current toner region nor the information about the amount of the residual toner which is written to the preceding writing region, it is decided that the first cartridge has been exchanged.

Apparently, it is possible to decide that the exchange has not been carried out in the case that the information about the amount of the residual toner in the identification information read from the first cartridge memory is coincident with the information about the amount of the residual toner which is written to the current toner region.

In the case that the information about the amount of the residual toner in the identification information read from the first cartridge memory is not coincident with the information about the amount of the residual toner which is written to the current toner region but the information about the amount of the residual toner which is written to the preceding writing region, moreover, it can be decided that the transmission of a dot count value for the same color from the image processing controller 102 is delayed in the update of the identification information after a last development before the power supply is turned ON or the body cover is closed for the first cartridge and the current amount of the residual toner cannot be written to a region for the cartridge of the same color in the current toner region of the body memory 105 before a timing for write to the cartridge memory is reached, and furthermore, the current information about the amount of the residual toner is written to the cartridge memory in the update of the identification information after the subsequent development as described above. For this reason, there is not a problem even if it is decided that the exchange has not been carried out.

When it is decided that the first cartridge has been exchanged at the Step S45, the unit controller 101 overwrites the identification information read from the first cartridge memory at the Step S44 to a region for writing the identification information about the cartridge for the first color in the body memory 105 (Step S46). At this time, the information about the amount of the residual toner which is read from the cartridge memory is written to both the current toner region for the color of the first cartridge and the preceding writing region. Consequently, the identification information about the cartridge for the same color in the body memory 105 is updated.

On the other hand, when it is decided that the first cartridge has not been exchanged at the Step S45, the processing proceeds to Step S47 in which it is decided whether the processing has been ended for all of the four cartridges.

When the processing for the first cartridge is ended, accordingly, the unit controller 101 then repeats the processings from the Step S43 to the Step S47 for second, third and fourth cartridges. When the processings are carried out for all of the four cartridges, they are ended.

As described above, in the second embodiment, it is decided whether the cartridge has been exchanged or not. For only the cartridge which is decided to be exchanged, the identification information about the cartridge of the body memory 105 is updated. Therefore, it is possible to prevent an error from being made between the amount of the residual toner which is managed by the body memory 105 and the actual amount of the residual toner in the same cartridge. Moreover, the information about the amount of the residual toner is used as information for deciding whether the cartridge has been exchanged or not. Consequently, whether the exchange has been carried out can be decided with high precision.

As a result, also in the case that the cartridge is exchanged when the unit controller 101 cannot recognize that the cartridge is exchanged, for example, when the body cover is opened during the rotation of the developing rotary unit 50 or the power supply is turned OFF, it is possible to carry out an accurate lifetime management for the cartridge.

### Third Embodiment

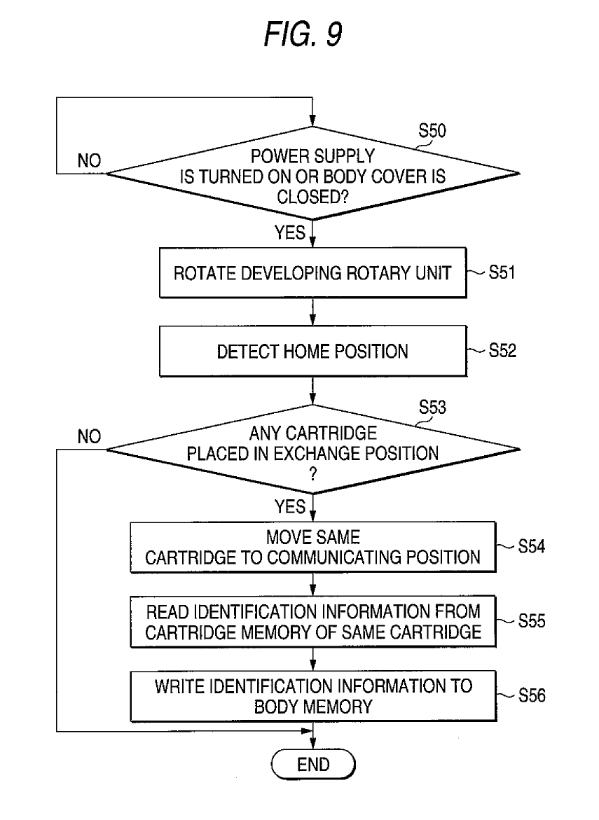

In a third embodiment, in the case that there is a cartridge which might have been exchanged, identification information about the cartridge in the body memory 105 is forcibly updated with identification information read from the cartridge memory of the cartridge, and description will be given with reference to a flowchart shown in FIG. 9.

When detecting that the power switch 108 is turned ON and the power supply is thus turned ON or detecting that the body cover is closed depending on the state of the body cover opening and closing detection switch 109 (in the case that a decision at Step S50 is yes), the unit controller 101 controls the rotary driving portion 107 to rotate the developing rotary unit 50 (Step S51). At this time, the rotary driving portion 107 supplies a driving pulse to a stepping motor and rotates the developing rotary unit 50. In this case, the unit controller 101 fetches a driving pulse output from the rotary driving portion 107 and counts the number of driving pulses from the time that an instruction for starting the rotation is given to the rotary driving portion 107.

Then, a detection signal is output from the HP sensor 106. Based on the number of driving pulses counted from the time that the instruction for the rotation is given to the rotary driving portion 107 to the time that the detection signal is received from the HP sensor 106 (Step S52), the unit controller 101 decides whether any cartridge is placed in the exchange position or not and decides the color of the cartridge if any (Step S53).

More specifically, one HP is present for one rotation of the developing rotary unit 50, and the position of the cartridge for each color in the developing rotary unit 50 is determined and is registered in the unit controller 101. Moreover, the number of rotations of the developing rotary unit 50 in one driving pulse is also registered in the unit controller 101. Accordingly, the unit controller 101 can find the number of rotations of the developing rotary unit 50 from the number of driving pulses counted from the time that the instruction for starting the rotation is given to the rotary driving portion 107 to the detection of the HP, and can decide whether any cartridge is placed in the exchange position or not and can decide the color of the cartridge if any.

When the unit controller 101 decides that the cartridge placed in the exchange position is not present at the Step S53, the processing is ended. If it is decided that a cartridge for a certain color is placed in the exchange position, the cartridge for the same color is moved to the communicating position (Step S54) and all of the identification information are read from the cartridge memory of the cartridge (Step S55), and the identification information thus read are written to the region for writing the identification information about the cartridge for the same color in the body memory 105 (Step S56). Thus, this processing is ended.

The processings at the Steps S55 and S56 are the same as the processings at the Steps S28 and S29 in FIG. 7. In the processing at the Step S56, moreover, when the identification information read from the cartridge memory is to be written to the body memory 105, the information about the amount of the residual toner which is read from the cartridge memory is written to both the current toner region for the color of the cartridge and the preceding writing region.

As described above, in the third embodiment, if there is a cartridge placed in the exchange position when the power supply is turned ON or the body cover is closed, the identification information about the cartridge in the body memory 105 is forcibly updated with the identification information read from the cartridge memory of the cartridge on the assumption that the cartridge has been exchanged.

As described above, according to the third embodiment, also in the case that the cartridge is exchanged when the unit controller 101 cannot recognize that the cartridge is exchanged, for example, when the body cover is opened during the rotation of the developing rotary unit 50 or the power supply is turned OFF, therefore, it is possible to carry out an accurate lifetime management for the cartridge.

### Fourth Embodiment

In the third embodiment described above, the cartridge placed in the exchange position when the power supply is turned ON or the body cover is closed is treated to be exchanged and the identification information about the cartridge of the body memory 105 is forcibly updated with the identification information read from the cartridge memory of the cartridge. In that case, however, there is a possibility that an error might be made between the amount of the residual toner managed by the body memory 105 and the actual amount of the residual toner in the cartridge in relation to the cartridge placed in the exchange position for the same reason as that described at the beginning of the second processing configuration.

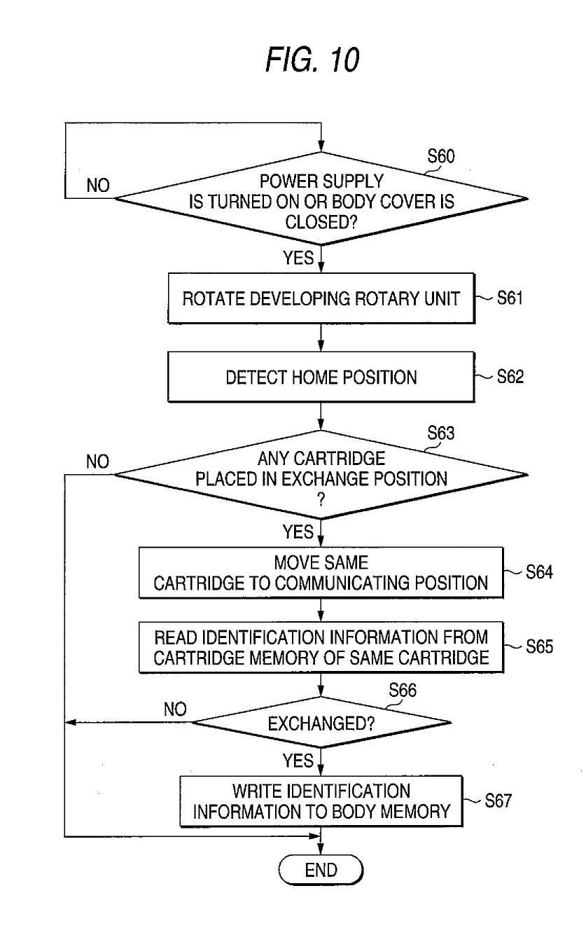

A fourth embodiment serves to avoid such a situation and a flowchart for the processing is shown in FIG. 10. The processings of Steps S60, S61, S62, S63, S64 and S65 in FIG. 10 are identical to those of the Steps S50, S51, S52, S53, S54 and S55 in FIG. 9 respectively, and the processings of Steps S66 and S67 in FIG. 10 are identical to those of the Steps S45 and S46 in FIG. 8 respectively.

Accordingly, repetitive and brief description will be given to the processing in FIG. 10. When detecting that the power switch 108 is turned ON and the power supply is thus turned ON or detecting that the body cover is closed depending on the state of the body cover opening and closing detection switch 109 (in the case that a decision at Step S60 is yes), the unit controller 101 rotates the developing rotary unit 50 (Step S61). At this time, the unit controller 101 fetches a driving pulse output from the rotary driving portion 107 and counts the number of driving pulses from the time that an instruction for starting the rotation is given to the rotary driving portion 107.

Then, a detection signal is received from the HP sensor 106 (Step S62). Based on the number of driving pulses counted from the time that the instruction for the rotation is given to the rotary driving portion 107 to the time that the detection signal is received from the HP sensor 106, the unit controller 101 decides whether any cartridge is placed in the exchange position or not and decides the color of the cartridge if any (Step S63).

When the unit controller 101 decides that any cartridge is not placed in the exchange position at the Step S53, the processing is ended. If it is decided that a cartridge for a certain color is placed in the exchange position, the cartridge for the same color is moved to the communicating position (Step S64) and all of the identification information are read from the cartridge memory of the cartridge (Step S65).

When reading the identification information from the cartridge memory, the unit controller 101 decides whether the cartridge has actually been exchanged or not (Step S66).

Whether the cartridge has actually been exchanged is decided at the Step S66 by comparing the identification information read from the cartridge memory at the Step S65 with the identification information written corresponding to the cartridge in the body memory 105. As described above, the information about the amount of the residual toner is used for the information to be utilized for making the comparison.

Therefore, the unit controller 101 decides that the cartridge placed in the exchange position has not been exchanged if the information about the amount of the residual toner in the identification information read from the cartridge memory at the Step S65 is coincident with either the information about the amount of the residual toner which is written to the current toner region or the information about the amount of the residual toner which is written to the preceding writing region, and decides that the cartridge has been exchanged if the information about the amount of the residual toner in the identification information read from the cartridge memory is coincident with neither the information about the amount of the residual toner which is written to the current toner region nor the information about the amount of the residual toner which is written to the preceding writing region.

When it is decided that the cartridge has actually been exchanged at the Step S66, then, the unit controller 101 overwrites the identification information read from the cartridge memory at the Step S65 to a region for writing the identification information about the cartridge for the same color in the body memory 105 (Step S67). At this time, the information about the amount of the residual toner which is read from the cartridge memory is written to both the current toner region for the color of the same cartridge and the preceding writing region. Consequently, the identification information about the cartridge for the same color in the body memory 105 is updated.

On the other hand, when it is decided that the same cartridge has not been exchanged at the Step S66, the unit controller 101 ends the processing.

In the fourth embodiment, thus, if any cartridge is placed in the exchange position when the power supply is turned ON or the body cover is closed, it is decided whether the cartridge has actually been exchanged or not. Only in the case that the cartridge has actually been exchanged, the identification information of the body memory 105 is updated. This is based on a thought that the cartridge is not always exchanged even if there is the cartridge placed in the exchange position when the power supply is turned ON or the body cover is closed.

As described above, in the fourth embodiment, if any cartridge is placed in the exchange position when the power supply is turned ON or the body cover is closed, the cartridge might have been exchanged, and furthermore, it is decided whether the cartridge has actually been exchanged or not. If it is decided that the cartridge has been exchanged, the identification information about the cartridge of the body memory 105 is updated. Therefore, it is possible to prevent an error from being made between the amount of the residual toner which is managed by the body memory 105 and the actual amount of the residual toner in the same cartridge. Moreover, the information about the amount of the residual toner is used as information for deciding whether the cartridge has been exchanged or not. Consequently, whether the exchange has been carried out can be decided with high precision.

As a result, also in the case that the cartridge is exchanged when the unit controller 101 cannot recognize that the cartridge is exchanged, for example, when the body cover is opened during the rotation of the developing rotary unit 50 or the power supply is turned OFF, it is possible to carry out an accurate lifetime management for the cartridge.

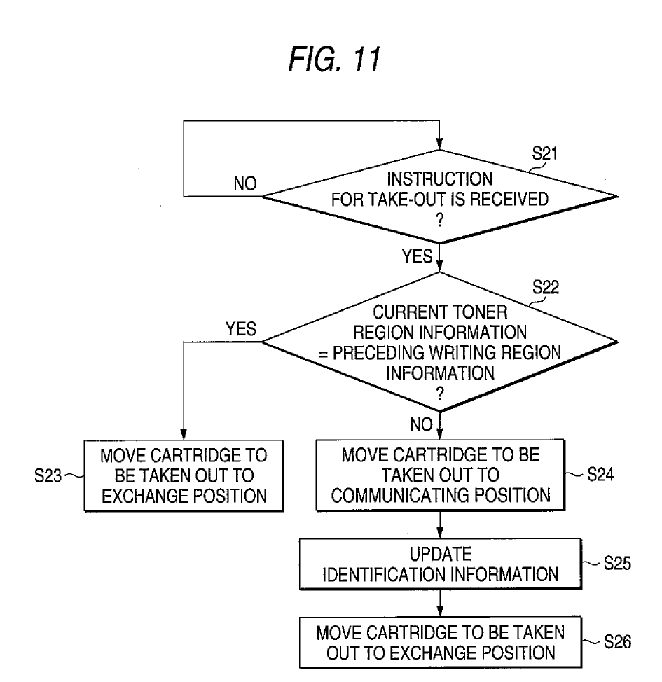

Next, a fifth embodiment of the invention will be described with reference to FIG. 11. This operation shown in FIG. 11 is carried out when the take-out operating portion 206 is operated to give an instruction for taking out a cartridge for a certain color.

A user gives an instruction for taking out a cartridge for a Y color by the take-out operating portion 206. At this time, the unit controller 101 receives, from the take-out operating portion 206, a control signal indicating that an instruction for taking out the cartridge for the Y color is given. Upon receipt of the control signal, the unit controller 101 decides that the instruction for take-out is given at Step S21, and subsequently, compares information about a region for the cartridge for the Y color in the current toner region of the body memory 105 with information about a region for the cartridge for the Y-color in a preceding writing region and decides whether they are coincident with each other or not (Step S22).

If they are coincident with each other (yes at the Step S22), the cartridge for the Y color may be exactly taken out because the current identification information including the current amount of a residual toner is written to the cartridge memory of the cartridge for the Y color. In this case, the unit controller 101 controls the rotary driving portion 107 to move the cartridge for the Y color to the exchange position (Step S23). Consequently, the user can take out the cartridge for the Y color and can attach a new cartridge for the Y color.

If they are not coincident with each other (no at the Step S22), however, the current amount of a residual toner is not written to the cartridge memory of the cartridge for the Y color. If the cartridge is set to be exactly taken out, consequently, the accurate lifetime management of the same cartridge cannot be carried out. In this case, therefore, the unit controller 101 controls the rotary driving portion 107 to move the cartridge for the Y color to the communicating position (Step S24) and to communicate with the cartridge memory of the cartridge for the Y color, thereby updating the identification information of the cartridge memory (Step S25).

At this time, the unit controller 101 writes, as the amount of a residual toner, the information about the amount of the residual toner in the region for the Y-color cartridge in the current toner region of the body memory 105. Therefore, the identification information of the cartridge memory is updated to the current information including the information about the residual toner. When updating the identification information of the cartridge memory, moreover, the unit controller 101 writes the information about the amount of the residual toner for the Y-color cartridge in the current toner region of the body memory 105 to a region for the Y-color cartridge in the preceding writing region. Referring to the Y color, consequently, the information in the region for the Y-color cartridge in the current toner region is coincident with the information in the region for the Y-color cartridge in the preceding writing region.

When the identification information of the cartridge memory is updated, the unit controller 101 controls the rotary driving portion 107 to move the cartridge for the Y color to the exchange position (Step S26). Consequently, the user can take out the cartridge for the Y color and can attach a new cartridge for the Y color.

As described above, according to the operation, in the case that the current identification information is written to the cartridge memory of the cartridge specified to be taken out, the cartridge is set to be immediately taken out so that the waiting time of the user can be shortened. In the case that the current identification information is not written, moreover, the cartridge is set to be taken out after the current identification information is written to the cartridge memory of the cartridge so that the current identification information can be written to the cartridge memory of the cartridge thus taken out.

While the above description has been given to the case that the event for updating the identification information written to the cartridge memory is the development, it is only illustrative and is not restricted.

Although the invention has been illustrated and described for the particular preferred embodiments, it is apparent to a person skilled in the art that various changes and modifications can be made on the basis of the teachings of the invention. It is apparent that such changes and modifications are within the spirit, scope, and intention of the invention as defined by the appended claims.

The present application is based on Japan Patent Application No. 2004-235762 filed on Aug. 13, 2004 and Japan Patent Application No. 2004-261968 filed on Sep. 9, 2004, the contents of which are incorporated herein for reference.

1-3. (canceled)

4. An image forming apparatus, comprising:
a developing rotary unit configured to attach a plurality of developing cartridges, the developing cartridges respectively having cartridge storage portions for respectively storing identification information about the corresponding developing cartridges;
a communicating unit that communicates with the cartridge storage portions;
a storage unit configured to store the identification information; and
a control unit that determines whether any of the developing cartridges is located at an exchange position in the developing rotary unit and determines whether the identification information stored in the storage unit is updated based on a result of the determination when a power supply of the image forming apparatus is turned ON or a body cover for the developing rotary unit is closed.

5. The image forming apparatus as set forth in claim 4, wherein the control unit reads the identification information from the cartridge storage portion located at the exchange position through the communicating unit and compares the read identification information with the identification information stored in the storage unit; and
wherein the control unit determines whether the identification information stored in the storage unit is updated based on a result of the comparison.

6-8. (canceled)

9. A method of determining update of identification information, comprising:
determining whether any of developing cartridges is located at an exchange position in a developing rotary unit of an image forming apparatus; and
determining whether identification information stored in a storage unit of the image forming apparatus is updated based on a result of the determining process of the exchange position,
wherein the determining process of the exchange position and the determining process of the update are performed when a power supply of the image forming apparatus is turned ON or a body cover for the developing rotary unit of the image forming apparatus is closed; and
wherein the developing rotary unit includes the developing cartridges, the developing cartridges respectively having the cartridge storage portions for respectively storing the identification information about the corresponding developing cartridges.

10. The method as set forth in claim 9, further comprising;
reading the identification information from the cartridge storage portion located at the exchange position through a communicating unit; and
comparing the read identification information with the identification information stored in the storage unit,
wherein the determining process is performed based on a result of the comparing process.

11. An image forming apparatus, comprising:
a developing rotary unit configured to attach a plurality of developing cartridges, the developing cartridges respectively having cartridge storage portions;
a communicating unit that communicates with the cartridge storage portions; and
a storage unit configured to store identification information about amounts of residual toners in the respective developing cartridges,
wherein the storage unit includes a first storage region for storing current toner remaining amount information and a second storage region for storing a preceding writing toner remaining amount information.

12. The image forming apparatus as set forth in claim 11, further comprising:
a receiving unit that receives an instruction for taking out the developing cartridge; and
a control unit that determines whether the current toner remaining amount information, for the developing cartridge specified by the instruction, stored in the first storage region corresponds to the preceding writing toner remaining amount information about the developing cartridge specified by the instruction, stored in the second storage region,
wherein the developing cartridge specified by the instruction is moved to an exchange position in the developing rotary unit when the current toner remaining amount information is corresponded to the preceding writing toner remaining amount information; and
wherein the developing cartridge specified by the instruction is moved to the exchange position after updating the identification information stored in the cartridge storage portion of the developing cartridge specified by the instruction with the current toner remaining amount information through the communication unit when the current toner remaining amount information is not corresponded to the preceding writing toner remaining amount information.

13. A method of determining update of identification information, comprising:
receiving an instruction for taking out any of developing cartridges;
determining whether a current toner remaining amount information about the developing cartridge specified by the instruction, stored in a first storage region corresponds to a preceding writing toner remaining amount information about the developing cartridge specified by the instruction, stored in a second storage region;
moving the developing cartridge specified by the instruction to an exchange position in a developing rotary unit when the current toner remaining amount information is corresponded to the preceding writing toner remaining amount information; and
moving the developing cartridge specified by the instruction to the exchange position after updating the identification information stored in the cartridge storage portion of the developing cartridge specified by the instruction with the current toner remaining amount information through a communication process when the current toner remaining amount information is not corresponded to the preceding writing toner remaining amount information.
